(19) United States
(12) Patent Application Publication
(10) Pub. No.: US 2009/0297898 A1
(43) Pub. Date: Dec. 3, 2009

(54) REFORMING SYSTEM, METHOD FOR OPERATING A REFORMING SYSTEM AND FUEL CELL SYSTEM

(75) Inventors: Matthias Boltze, Wulkenzin (OT Neuendorf) (DE); Michael Rozumek, Neubrandenburg (DE); Stefan Kading, Zerrentin (DE); Manfred Pfalzgraf, Herrsching am Ammersee (DE); Andreas Engl, Munich (DE); Beate Bleeker, Munich (DE); Michael Sussl, Munich (DE); Markus Bedenbecker, Gauting (DE); Stefan Kah, Neubrandenburg (DE); Andreas Lindermeir, Goslar (DE); Norbert Gunther, Ribnitz (DE); Johannes Eichstadt, Neubrandenburg (DE); Marco Muhlner, Raduhn (DE)

Correspondence Address: FITCH EVEN TABIN & FLANNERY, 120 SOUTH LASALLE STREET, SUITE 1600, CHICAGO, IL, 60603-3406, US

(73) Assignee: ENERDAY GMBH, Neubrandenburg (DE)

(21) Appl. No.: 12/522,006

(22) PCT Filed: Nov. 19, 2007
(86) PCT No.: PCT/DE07/02093

§ 371 Date: Jul. 2, 2009

(30) Foreign Application Priority Data
Jan. 9, 2007 (DE) 10 2007 001 382.7

(51) Int. Cl. H01M 8/04; H01M 8/18

(52) U.S. Cl. 429/17; 429/20

(57) ABSTRACT

The invention relates to a reformer system for generating a hydrogen-rich reformate comprising a reformer to which fuel and an oxidising agent can be supplied. According to the invention it is contemplated that the fuel supplied to the reformer is at least partly coolable by a fluid having other functions in addition to the function of cooling the fuel in the reformer system or a parent system into which the reformer system is integrated. The invention further relates to a method for generating a hydrogen-rich reformate as well as a fuel cell system comprising a reformer system according to the invention.

The invention relates to a reformer system for generating a hydrogen-rich reformate comprising a reformer to which fuel and an oxidising agent can be supplied.

The invention further relates to a method for generating a hydrogen-rich reformate comprising a reformer to which fuel and an oxidising agent can be supplied.

The invention further relates to a fuel cell system.

Reformer systems are used to generate a hydrogen-rich reformate from fuel and oxidising agents. In fuel cell systems said reformate may then be supplied to a fuel cell arrangement generating electric energy from the starting materials hydrogen and oxygen.

The thermodynamic and reaction-kinetic processes within the reformer are complex. They particularly depend on the properties of the supplied materials, i.e. the gaseous or liquid fuel and the air generally supplied as oxidising agent. In any case, it is aspired to make the processes within the reformer as reproducible as possible so that a stable operation of the reformer system and a fuel cell system can be guaranteed.

The invention is based on the object to develop the properties of the materials supplied to the reformer so that a stable reforming operation can be achieved which should, in particular, be realised by taking efficient and reliable measures requiring a low complexity of the device.

Said object is solved by the features of the independent claims.

Advantageous embodiments of the invention are specified in the dependent claims.

The invention is based on the generic reformer system in that the fuel supplied to the reformer is at least partly coolable by a fluid having other functions in addition to the function of cooling the fuel within the reformer system or a parent system into which the reformer system is integrated. It has been found that the cooling of the fuel supplied to the reformer can have an advantageous effect on the operation of the reformer. On the one hand, this relates to the temperature of the fuel as such, and, on the other hand, the provision of fuel having a, to a large extent, unchanged temperature during operation. Such cooling can be provided in a particularly efficient manner by establishing a heat-exchanging relation between the fuel and a fluid which may, in addition to a mere cooling function, have other functions within the reformer system or a parent system.

It may, for example, be contemplated that the fluid is air supplied to the reformer as an oxidising agent.

It is also possible that the fluid is air used as cathode supply air for a fuel cell arrangement downstream of the reformer.

According to a further useful embodiment of the invention, the fluid is air used as combustion air for an afterburner downstream of the reformer.

It may also be contemplated that the fluid is a cooling fluid also serving to cool an internal combustion engine of a motor vehicle provided with the reformer system.

It may further be contemplated that the fluid is air used for cooling components of the reformer.

With respect to the device, the reformer system according to the invention may be realised in a particularly useful manner by guiding the fluid and the fuel through two pipes disposed one inside of the other. For example, the process air supplied to the reformer may be introduced into the reformer through a pipe surrounding a fuel pipe. Comparable solutions may be chosen in connection with other air and liquid flows.

The invention is based on the generic method in that the fuel supplied to the reformer is at least partly cooled by a fluid having other functions in addition to the fuel cooling function in the reformer system or a parent system into which the reformer system is integrated. In this way, the advantages and particularities of the reformer system according to the invention are also realised within the framework of a method. This also applies to the particularly preferred embodiments of the method according to the invention described below.

This is further developed in a useful manner in that the fluid is air supplied to the reformer as an oxidising agent.

It may further be contemplated that the fluid is air used as cathode air for a fuel cell arrangement downstream of the reformer.

Another option is that the fluid is air used as combustion air for an afterburner downstream of the reformer.

It is also possible that the fluid is a cooling liquid also used for cooling an internal combustion engine of a motor vehicle provided with the reformer system.

It may further be contemplated that the fluid is air used for cooling components of the reformer.

The method according to the invention is realisable in a particularly useful manner in that the fluid and the fuel are guided through two pipes disposed one inside of the other.

The invention further relates to a fuel cell system comprising a reformer system according to the invention.

The invention will now be described by way of example with respect to particularly preferred embodiments with reference to the accompanying drawings in which:

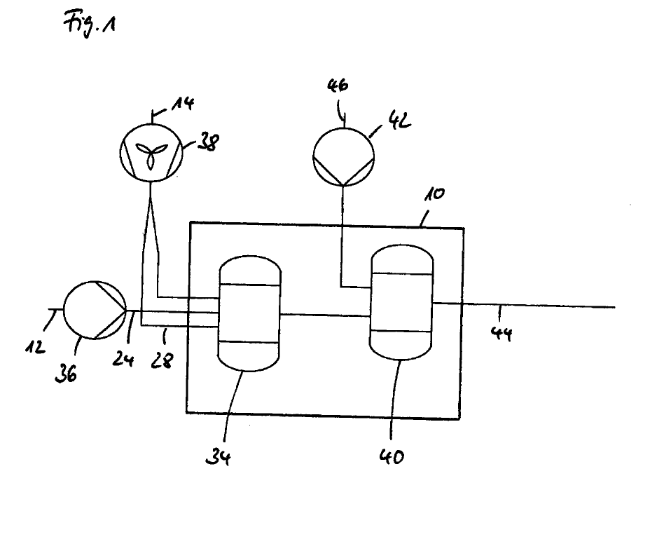

FIG. 1 shows a schematic representation of a first embodiment of a reformer system according to the invention;

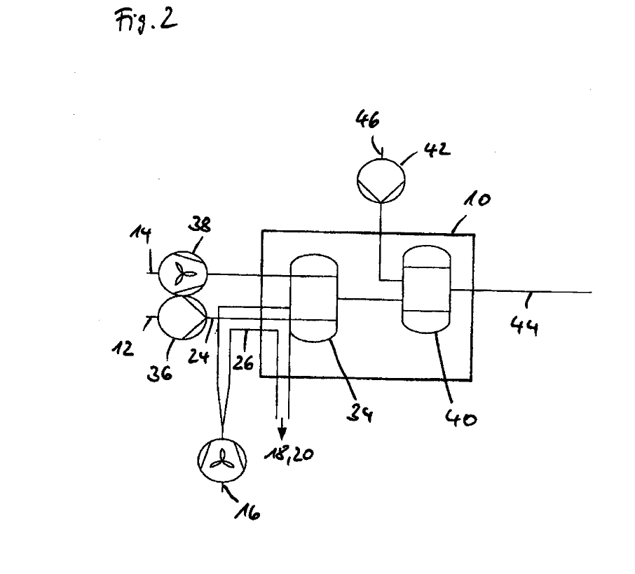

FIG. 2 shows a schematic representation of a second embodiment of a reformer system according to the invention;

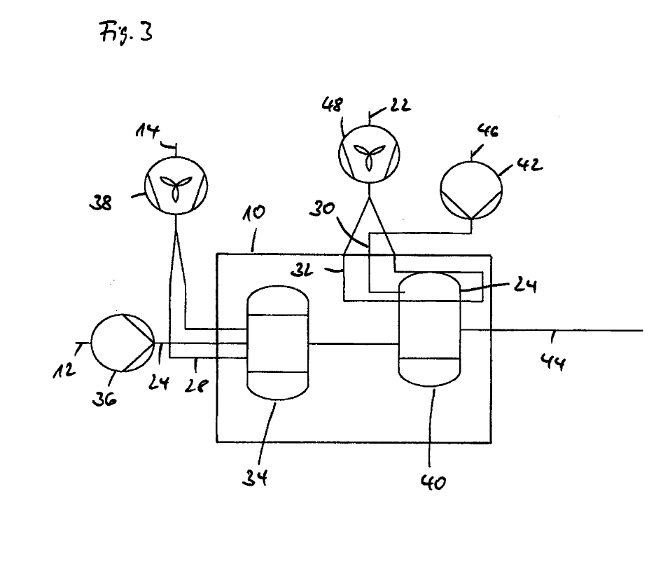

FIG. 3 shows a schematic representation of a third embodiment of a reformer system according to the invention;

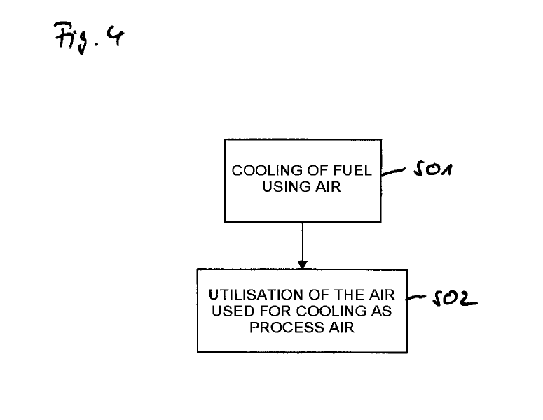

FIG. 4 shows a flow chart for explaining a method according to the invention.

In the following description of the drawings identical numerals designate the same or comparable components.

FIG. 1 shows a schematic representation of a first embodiment of a reformer system according to the invention. A reformer 10 designed for a reforming process including two process stages is shown. A first section 34 of the reformer 10 is supplied with fuel 12 or air 14 by a pump 36 and a fan 38. In said first section 34 exothermal oxidation reactions take place the products of which are supplied to a second section 40. Said second section 40 is supplied with further fuel 46 by another pump 42. In the second section 40 provided with a catalytic converter then the actual endothermic reforming takes place in which a hydrogen-rich reformate 44 is generated which may then be made available for other applications, particularly a fuel cell stack. Downstream of the pump 36 a fuel line 24 is provided for supplying the fuel to the reformer 10. Likewise a line 28 for introducing the air 14 into the reformer 10 is provided downstream of the fan 38. Said lines 24, 28 are, at least in sections, arranged so that the air-containing line 28 surrounds the fuel-containing line 24 whereby the fuel 12 is cooled.

FIG. 2 shows a schematic representation of a second embodiment of a reformer system according to the invention. The system shown here differs from the reformer system described in connection with FIG. 1 with respect to the air and fuel supply to the first section 34 of the reformer 10. The process air 14 used in the first section 34 of the reformer 10 is directly supplied to said section 34 without being previously used for cooling fuel. The fuel 12 is, in case of this second embodiment, cooled by air 16 supplied to cathodes 18 of a fuel cell stack or to an afterburner 20 after having fulfilled its cooling function. Again the lines 24, 26 for the fuel 12 and the air 16 form a pipe-in-pipe structure comparable to the arrangement shown in FIG. 1.

FIG. 2 therefore shows an embodiment in which the air 16 used for cooling the fuel is not meant for a further use in the reformer system itself but supplied to a component of a parent system, in this case a fuel cell system comprising a fuel cell stack and an afterburner. The fuel 12 may be cooled in a comparable manner using a cooling liquid of a motor vehicle fulfilling the function of cooling the internal combustion engine of the motor vehicle in addition to its function of cooling the fuel of the reformer.

FIG. 3 shows a schematic representation of a third embodiment of a reformer system according to the invention. With respect to the mixture supply to the oxidation section 34 FIG. 3 is designed in the same manner as the first embodiment according to FIG. 1. In addition the fuel 46 supplied to the reforming section 40 of the reformer 10 is cooled. For this purpose a further fan 48 is provided which supplies air to the reforming section 40 via a line 32. The line 30 for introducing the fuel 46 into the reforming section 40 is at least partly surrounded by the air guidance line 32. In addition to cooling the fuel line 30 the air 22 supplied for this purpose also cools an evaporation section 24 upstream of the actual reforming section 40.

FIG. 3 shows an embodiment of a reformer system to a first section 34 of which fuel 12 and air 14 are supplied as reactants while a second section 40 is only supplied with further fuel 46 from the outside. It is also feasible that the second section 40 is also supplied with further air. This process air may also be used for cooling the fuel supply.

The embodiment according to FIG. 3 is based on the embodiment according to FIG. 1 with respect to the supply of the mixture to the first section 34 of the reformer 10. It is also possible to realise the fuel cooling for the first section 34 of the reformer 10 as described in connection with FIG. 2 and to realise a fuel cooling for the second section 40 on this basis in the manner shown in FIG. 3. It is also possible to omit the fuel cooling for the first section 34.

FIG. 4 shows a flow chart for explaining the method according to the invention. In a first step S01 of the operating method according to the invention it is contemplated that fuel supplied to a reformer is cooled by air. In a following step S02 the air used for cooling is then used as process air. It is, for example, supplied to the oxidising zone or the reforming zone of the reformer. It is also possible to use the air for cooling components of the reformer or other components of the fuel cell stack. Further the air can be used as cathode supply air or as combustion air for an afterburner. In addition to the utilisation of air for cooling it is also possible to use a cooling liquid of the internal combustion engine of a motor vehicle for cooling the fuel and to bestow it with a double function in this way.

The features of the invention disclosed in the above description, in the drawings as well as in the claims may be important for the realisation of the invention individually as well as in any combination.

### LIST OF NUMERALS

10 reformer

12 fuel

14 air/fluid

16 air/fluid

18 cathode

20 afterburner

22 air/fluid

24 line/pipe

26 line/pipe

28 line/pipe

30 fuel line/pipe

32 air guidance line/pipe

34 first section/oxidising section

36 pump

38 fan

40 second section/reforming section

42 pump

44 reformate

46 fuel

48 fan

1. A reformer system for generating a hydrogen-rich reformate, said reformer system comprising a reformer to which fuel and an oxidising agent can be supplied, wherein the fuel supplied to the reformer is at least partly coolable by a fluid having other functions in addition to the function of cooling the fuel within the reformer system or a parent system into which the reformer system is integrated.

2. The reformer system of claim 1, wherein the fluid is air supplied to the reformer as an oxidising agent.

3. The reformer system of claim 1, wherein the fluid is air used as cathode supply air for a fuel cell arrangement downstream of the reformer.

4. The reformer system of claim 1, wherein the fluid is air used as combustion air for an afterburner downstream of the reformer.

5. The reformer system of claim 1, wherein the fluid is a cooling fluid also serving to cool an internal combustion engine of a motor vehicle provided with the reformer system.

6. The reformer system of claim 1, wherein the fluid is air used for cooling components of the reformer.

7. The reformer system of claim 1, wherein the fluid and the fuel are passed through two pipes disposed one inside of the other.

8. A method for generating a hydrogen-rich reformate, said method comprising the step of: supplying fuel and an oxidising agent to a reformer wherein the fuel supplied to the reformer is at least partly cooled by a fluid having other functions in addition to the function of cooling the fuel in the reformer system or a parent system into which the reformer system is integrated.

9. The method of claim 8, wherein the fluid is air supplied to the reformer as an oxidising agent.

10. The method of claim 8, wherein the fluid is air used as cathode supply air for a fuel cell arrangement downstream of the reformer.

11. The method of claim 8, wherein the fluid is air used as combustion air for an afterburner downstream of the reformer.

12. The method of claim 8, wherein the fluid is a cooling liquid also used for cooling an internal combustion engine of a motor vehicle provided with the reformer system.

13. The method of claim 8, wherein the fluid is air used for cooling components of the reformer.

14. The method of claim 8 to 13, wherein the fluid and the fuel are passed through two pipes disposed one inside of the other.

15. A fuel cell system comprising a reformer system of claim 1.
